(19) United States
(12) Patent Application Publication
(10) Pub. No.: US 2021/0003407 A1
(43) Pub. Date: Jan. 7, 2021

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Akira SASAKI, Miyoshi-shi (JP); Jun HIOKI, Nagakute-shi (JP); Kazuki MATSUMOTO, Oogaki-shi (JP); Fumio WADA, Nagoya-shi (JP)

(73) Assignee: TOYOTA JIDOSHA KABUSHIKI KAISHA, Toyota-shi (JP)

(21) Appl. No.: 16/848,893

(22) Filed: Apr. 15, 2020

(30) Foreign Application Priority Data
Jul. 5, 2019 (JP) 2019-126016

(51) Int. Cl. G01C 21/34; H04W 4/44; H04W 4/024; H04W 24/04

(52) U.S. Cl. CPC G01C 21/3407; H04W 24/04; H04W 4/024; H04W 4/44

(57) ABSTRACT

An information processing apparatus includes a processor configured to receive, from a terminal, information about a departure place or a current position and information about a destination; based on field strength map information indicating a distribution of field strength in a first communication system, acquire a route from the departure place or the current position to the destination, of which communication quality in the first communication system satisfies a predetermined criterion; and send information about the acquired route to the terminal.

### INCORPORATION BY REFERENCE

The disclosure of Japanese Patent Application No. 2019-126016 filed on Jul. 5, 2019 including the specification, drawings and abstract is incorporated herein by reference in its entirety.

### BACKGROUND

### 1. Technical Field

The disclosure relates to an information processing apparatus and an information processing method.

### 2. Description of Related Art

Navigation systems with which a route to a destination can be selected from among multiple routes that satisfy respective conditions, such as general road priority, expressway priority, and distance priority, are known (for example, Japanese Unexamined Patent Application Publication No. 2006-322782 (JP 2006-322782 A)). In addition, wireless mobile terminals that provide map information indicating a distribution of reception field strength so that communication is not interrupted are known (for example, Japanese Unexamined Patent Application Publication No. 2002-112303 (JP 2002-112303 A)).

### SUMMARY

However, it is difficult for drivers to keep track of the field strength of wireless communication, for example, while moving in vehicles. On the other hand, even while moving in vehicles, drivers, for example, acquire traffic congestion information in currently traveling routes or use video distribution services. Thus, acquiring information through wireless communication plays an important role. However, in a poor communication environment, sufficient information may not be acquired while moving in vehicles. This inconvenience is not limited to while moving in vehicles, and similar inconvenience also occurs, for example, while walking.

One of embodiments of the disclosure provides an information processing apparatus and an information processing method that are able to provide a stable communication environment for a moving terminal.

One of the embodiments of the disclosure is an information processing apparatus. The information processing apparatus includes a processor configured to receive, from a terminal, information about a departure place or a current position and information about a destination; based on field strength map information indicating a distribution of field strength in a first communication system, acquire a route from the departure place or the current position to the destination, of which communication quality in the first communication system satisfies a predetermined criterion; and send information about the acquired route to the terminal.

Another one of the embodiments of the disclosure is an information processing method. The information processing method includes receiving, from a terminal, information about a departure place or a current position and information about a destination; based on field strength map information indicating a distribution of field strength in a first communication system, acquiring a route from the departure place or the current position to the destination, of which communication quality in the first communication system satisfies a predetermined criterion; and sending information about the acquired route to the terminal.

According to the disclosure, a stable communication environment can be provided for a moving terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that shows an example of the system configuration of a route suggestion system according to a first embodiment;

FIG. 2 is a diagram that shows an example of the hardware components of a center server and each in-vehicle apparatus in the route suggestion system;

FIG. 3 is a diagram that shows an example of the functional configuration of the center server and each in-vehicle apparatus in the route suggestion system;

FIG. 4 is a view that shows an example of a field strength map;

FIG. 5 is an example of a flowchart of a process that the center server executes upon receiving a connectivity-based route request from the in-vehicle apparatus;

FIG. 6 is a view that shows an example of a route selection screen of the in-vehicle apparatus;

FIG. 7 is an example of a flowchart of a process that the center server executes upon receiving a request to check connectivity in a route from the in-vehicle apparatus; and

FIG. 8 is a view that shows an example of a route change suggestion screen of the in-vehicle apparatus.

### DETAILED DESCRIPTION OF EMBODIMENTS

One of embodiments of the disclosure is an information processing apparatus. The information processing apparatus includes a processor configured to receive, from a terminal, information about a departure place or a current position and information about a destination; based on field strength map information indicating a distribution of field strength in a first communication system; acquire a route from the departure place or the current position to the destination, of which communication quality in the first communication system satisfies a predetermined criterion; and send information about the acquired route to the terminal.

Examples of the terminal include an in-vehicle apparatus, a smartphone, a tablet terminal, a wearable terminal, a mobile personal computer (PC), and a controller of an autonomous driving vehicle. Examples of the first communication system include the 5G (generation) mobile communication system and mobile communication systems after 5G. Examples of the predetermined criterion include any one or combination of a condition that the number of sections in which a field strength in the first communication system is lower than a first threshold is less than a predetermined number, a condition that the total distance of the sections in which the field strength in the first communication system is lower than the first threshold is less than a predetermined value, and a condition that the percentage of the total distance of the sections in which the field strength in the first communication system is lower than the first threshold to the total distance of all the sections in a route is lower than a predetermined value.

According to the one of the embodiments of the disclosure, information about a route from a departure place or a current position to a destination is provided based on the field strength map information. Therefore, the terminal is able to stably acquire information about a route in which the terminal performs communication in the first communication system.

In one of the embodiments of the disclosure, the processor may be configured to receive, from the terminal, information about a route currently in use; determine whether communication quality in the first communication system in at least a section from the current position of the terminal to the destination in the route currently in use satisfies the predetermined criterion; when the quality in the first communication system in the section in the route currently in use does not satisfy the predetermined criterion, acquire a first route from the current position of the terminal to the destination, of which communication quality in the first communication system satisfies the predetermined criterion; and send information about the first route to the terminal.

With this configuration, a user who has the terminal is able to acquire information about a first route of which the communication quality in the first communication system satisfies the predetermined criterion and is able to change routes from the route currently in use to the first route having better communication quality. For example, when the first communication system is high-capacity, high-speed 5G and the terminal has started downloading large video data, or the like, in 5G, there is a possibility that the download is interrupted if the communication quality of a route currently in use is poor. However, by changing the route to the first route, the possibility of interruption of the download is reduced.

In one of the embodiments of the disclosure, the processor may be configured to, when the communication quality in the first communication system in the section in a route currently in use does not satisfy the predetermined criterion and the first route is not acquired, provide the terminal with notification that there is a possibility of unstable communication in the first communication system. With this configuration, a user of the terminal may take measures by, for example, interrupting a download of large video data, or the like, by itself when the download has been started or changing a downloading object to a smaller one.

In one of the embodiments of the disclosure, the field strength map information may be created based on information about positions of one or more terminals and information about a reception field strength in the first communication system at each of the positions, sent from the one or more terminals. With this configuration, the information processing apparatus is able to, for example, even when information about a distribution of field strength in the first communication system cannot be obtained from a communication carrier, or the like, create field strength map information in the first communication system by itself based on information from terminals, that is, so-called big data.

Hereinafter, embodiments of the disclosure will be described with reference to the accompanying drawings. The configurations of the following embodiments are illustrative, and embodiments of the disclosure are not limited to the configurations of the embodiments that will be described below.

### First Embodiment

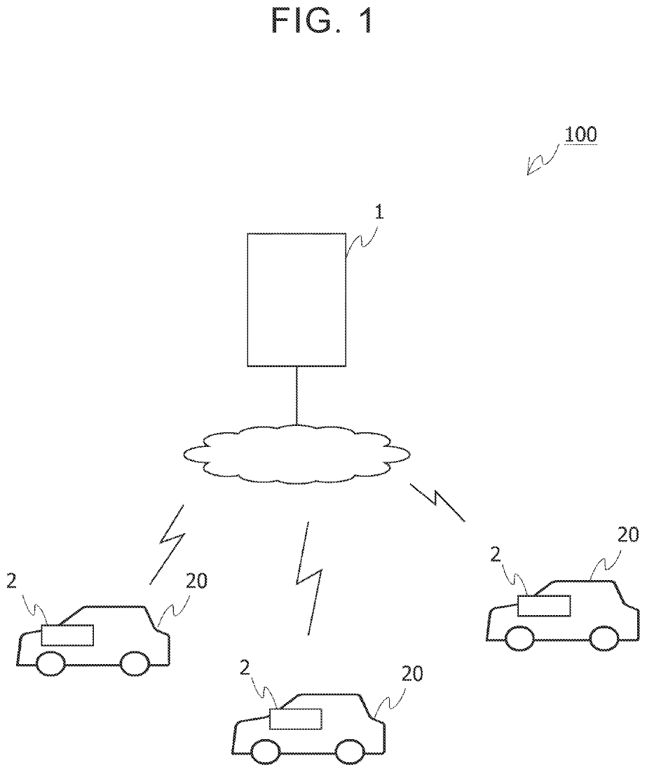

FIG. 1 is a diagram that shows an example of the system configuration of a route suggestion system 100 according to a first embodiment. The route suggestion system 100 is a system that suggests routes having good communication quality in a predetermined communication system based on, for example, a distribution of field strength in the predetermined communication system. Examples of the good communication quality include a condition that a field strength is stably higher than or equal to a predetermined threshold and a condition that a communication speed is stably higher than or equal to a predetermined threshold. The routes having good communication quality are routes that satisfy a predetermined criterion. Examples of the predetermined criterion include a condition that the number of sections in which a field strength is lower than a predetermined threshold is less than a predetermined number, a condition that the total distance of the sections in which the field strength is lower than the predetermined threshold is less than a predetermined value, and a condition that the percentage of the total distance of the sections in which the field strength is lower than the predetermined threshold to the total distance of all the sections in a route is lower than a predetermined value.

The route suggestion system 100 includes, for example, a center server 1, and in-vehicle apparatuses 2 respectively installed in a plurality of vehicles 20. The vehicles 20 each may be, for example, any one of a manual driving vehicle and an autonomous driving vehicle. The in-vehicle apparatuses 2 each may be, for example, any one of a data communication device, an in-vehicle apparatus of a car navigation system, and a controller that controls autonomous driving in the case where the vehicle 20 is an autonomous driving vehicle. The in-vehicle apparatuses 2 connect with a public network, such as the Internet, by using, for example, any one of mobile communication systems, such as 5G and long term evolution (LTE), and narrowband communication systems, such as dedicated short range communications (DSRC).

The center server 1 is connected to a network, such as the Internet. The center server 1 and each in-vehicle apparatus 2 are communicable via the network.

For example, communication in 5G has a communication speed equivalent to that of Wi-Fi, and is able to send or receive a massive amount of data in a shorter time. On the other hand, communication in 5G has high directivity, so radio waves may not reach areas behind obstacles, such as buildings, even in a coverage area. In other words, there can be some dotted areas unconnectable in 5G because radio waves do not reach those areas. 5G is an example of the first communication system.

For example, in the case where large video data is intended to be downloaded with the in-vehicle apparatus 2 while the vehicle 20 is traveling, when the vehicle 20 enters an area that 5G radio waves do not reach, 5G communication is interrupted, the download is interrupted or takes time, and there is a high possibility that a comfortable communication environment cannot be provided. Hence, in the first embodiment, the center server 1 has map information about a distribution of field strength in 5G and provides the in-vehicle apparatus 2 of the vehicle 20 with routes having good 5G communication quality as routes to a destination of the vehicle 20 based on the map information.

In the first embodiment, each of the in-vehicle apparatuses 2 sends positional information and a measured result of 5G field strength at the position to the center server 1 at predetermined intervals. The center server 1 holds the positional information and measured result of 5G field strength received from each in-vehicle apparatus 2 as big data and generates map information about a distribution of 5G field strength from the big data. Hereinafter, the map information about a distribution of field strength is referred to as field strength map. Not limited to this configuration, the center server 1 may acquire a field strength map on 5G from a communication carrier in advance.

In the first embodiment, in response to a request from the in-vehicle apparatus 2, the center server 1 generates routes having good 5G communication quality based on the field strength map and provides the routes to the in-vehicle apparatus 2. The in-vehicle apparatus 2 sends a request for providing routes having good 5G communication quality to the center server 1, for example, when a route is set at the time of starting to move to a destination, or when sending or receiving a massive amount of data is started. Hereinafter, the word “communication quality” means 5G communication quality.

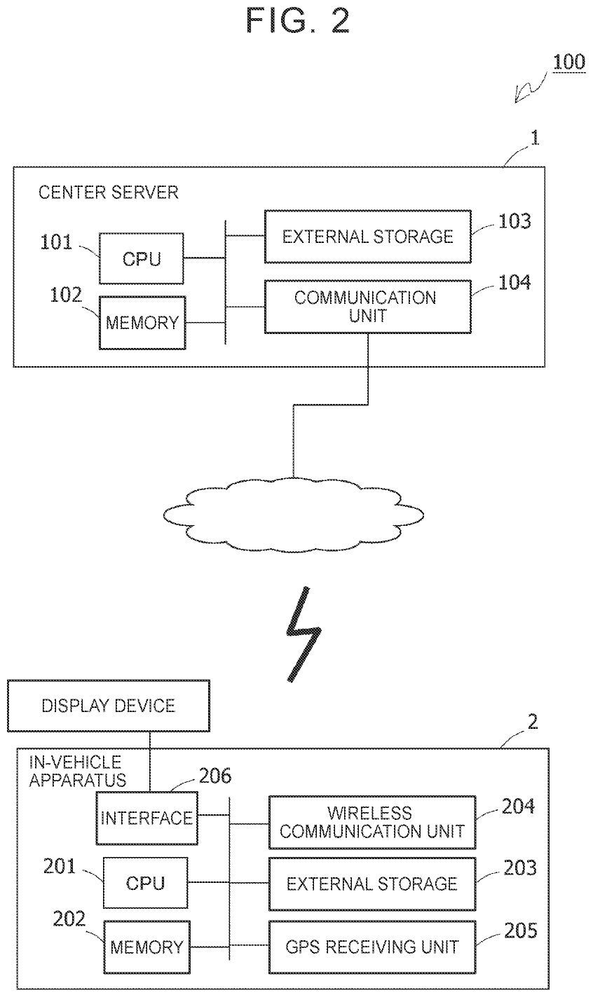

FIG. 2 is a diagram that shows an example of the hardware components of the center server 1 and each in-vehicle apparatus 2 in the route suggestion system 100. The center server 1 is, for example, an exclusive computer or a general-purpose computer. The center server 1 includes a central processing unit (CPU) 101, a memory 102, an external storage 103, and a communication unit 104 as hardware components. The memory 102 and the external storage 103 are computer-readable recording media. The center server 1 is an example of the information processing apparatus.

The external storage 103 stores various programs and data that the CPU 101 uses in running the programs. The external storage 103 is, for example, an erasable programmable ROM (EPROM) or a hard disk drive. Examples of the programs held in the external storage 103 include an operating system (OS), a control program of the route suggestion system 100, and other various application programs. The control program of the route suggestion system 100 is a program for suggesting routes having good communication quality to the in-vehicle apparatuses 2.

The memory 102 is a storage device that provides the CPU 101 with a storage area and work area on which the programs stored in the external storage 103 are loaded or that is used as a buffer. The memory 102 includes, for example, a read only memory (ROM) and a semiconductor memory, such as a random access memory (RAM).

The CPU 101 executes various processes by loading the OS and various application programs held in the external storage 103 onto the memory 102 and running the programs. The CPU 101 is not limited to a single one, and a plurality of the CPUs 101 may be provided. The CPU 101 is an example of the processor of the information processing apparatus.

The communication unit 104 is an interface that inputs or outputs information to or from a network. The communication unit 104 may be an interface that connects with a wired network or may be an interface that connects with a wireless network. The communication unit 104 is, for example, a network interface card (NIC), a wireless circuit, or the like. The communication unit 104, for example, connects with a local area network (LAN), connects with a public communication line network through the LAN, and communicates with various servers and in-vehicle apparatuses 2 on the network through the public communication line network.

Each in-vehicle apparatus 2 is, for example, a data communication device, car navigation system, ETC in-vehicle device, or the like, installed in the vehicle 20. When the vehicle 20 is an autonomous driving vehicle, the in-vehicle apparatus 2 may be a controller for autonomous driving with a communication function for connecting with a public network, such as the Internet. Each in-vehicle apparatus 2 is not limited to these devices. For example, each in-vehicle apparatus 2 may be a mobile terminal, such as a smartphone, a tablet terminal, and a wearable terminal, held by a user who rides the vehicle 20. Hereinafter, in the first embodiment, description will be made on the assumption that each in-vehicle apparatus 2 is a data communication device installed in the vehicle 20.

The in-vehicle apparatus 2 includes, for example, a CPU 201, a memory 202, an external storage 203, a wireless communication unit 204, a global positioning system (GPS) receiving unit 205, and an interface 206 as hardware components. The CPU 201, the memory 202, and the external storage 203 are similar to the CPU 101, the memory 102, and the external storage 103. However, the external storage 203 of the in-vehicle apparatus 2 stores, for example, a control program for the in-vehicle apparatus of the route suggestion system 100, and a navigation application. The control program for the in-vehicle apparatus of the route suggestion system 100 is, for example, a program for sending a request to acquire routes to the center server 1 and receiving suggestions for routes having good communication quality. The navigation application is an application that acquires a route to a designated destination and guides the route.

The wireless communication unit 204 is a wireless communication circuit for a mobile communication system, such as 5G, LTE, and LTE-Advanced (4G), Wi-Fi, DSRC, or the like. The wireless communication unit 204 wirelessly connects with an access network compliant with an associated one of the wireless communication systems, connects with the public communication line network through the access network, and connects with the center server 1, or the like, through the public communication line network. In the first embodiment, the wireless communication unit 204 is a wireless circuit for mobile communication systems and selects a network to use in priority order of 5G, 4G, and 3G.

The GPS receiving unit 205 receives radio waves of time signals from a plurality of artificial satellites orbiting around the earth and stores the time signals in a register provided in the CPU 201. The CPU 201, for example, acquires the positional information of the vehicle 20 (in-vehicle apparatus 2) by calculating a latitude and a longitude that indicate a position on the earth by using detected signals from the GPS receiving unit 205.

The interface 206 is, for example, an interface for connecting with a display device provided in the vehicle 20. The interface 206 may be directly connected by a cable, or the like, to the display device provided in the vehicle 20 or may be connected to an in-vehicle network (controller area network (CAN)) and then connected to the display device provided in the vehicle 20 through the CAN. The display device that is provided in the vehicle 20 and that connects with the in-vehicle apparatus 2 may be, for example, any one or plurality of a display device of a car navigation system, a display device installed for a rear seat, and the like. The display device that is provided in the vehicle 20 and that connects with the in-vehicle apparatus 2 may include a touch panel and also have the function of an input device.

The hardware components of the center server 1 and in-vehicle apparatus 2 shown in FIG. 2 are illustrative and are not limited thereto. Omissions, replacements, or additions of components are applicable as needed according to embodiments. For example, the center server 1 includes a portable recording medium drive and may run a program recorded on a portable recording medium. The portable recording medium is, for example, a recording medium, such as an SD card, a miniSD card, a microSD card, a universal serial bus (USB) flash memory, a compact disc (CD), a digital versatile disc (DVD), a Blu-ray (registered trademark) disc, and a flash memory card. For example, the center server 1 may include an input device and an output device. The input device is, for example, a keyboard, a mouse, a touch panel, or the like. The output device is, for example, a display, or the like.

A series of processes that the center server 1 and each in-vehicle apparatus 2 execute is not limited to the one implemented by a processor running software and may be implemented by, for example, hardware, such as field-programmable gate array (FPGA).

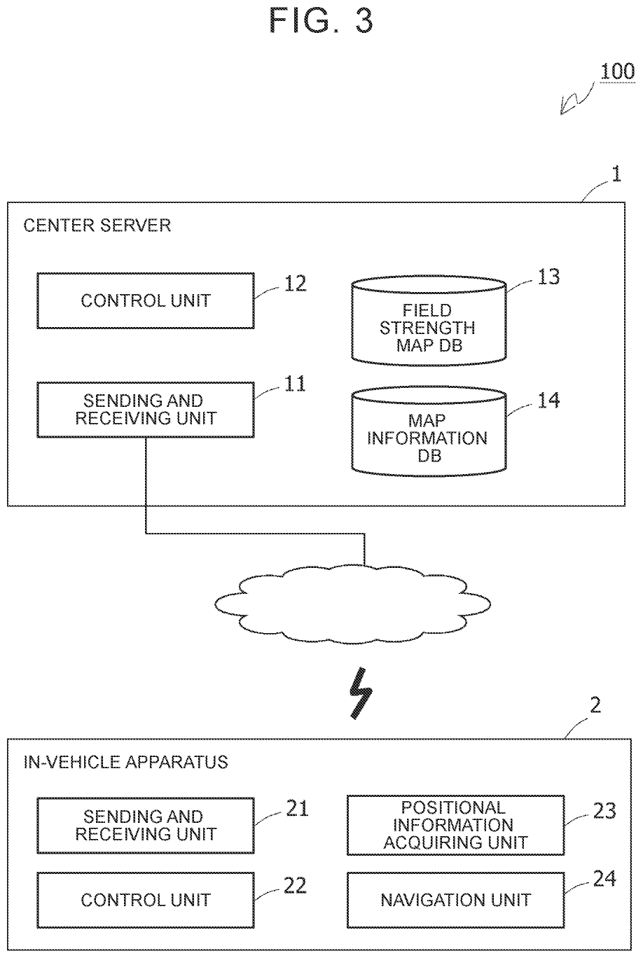

FIG. 3 is a diagram that shows an example of the functional configuration of the center server and each in-vehicle apparatus in the route suggestion system 100. The in-vehicle apparatus 2 includes a sending and receiving unit 21, a control unit 22, a positional information acquiring unit 23, and a navigation unit 24 as functional components. The control unit 22 is implemented, for example, when the CPU 201 of the in-vehicle apparatus 2 runs the control program for the in-vehicle apparatus 2 of the route suggestion system 100, stored in the external storage 203. The navigation unit 24 is implemented, for example, when the CPU 201 of the in-vehicle apparatus 2 runs the navigation application stored in the external storage 203. The sending and receiving unit 21 and the positional information acquiring unit 23 are implemented by, for example, the OS.

The sending and receiving unit 21 is an interface for communication with the network through the wireless communication unit 204. The sending and receiving unit 21, for example, receives input of a connectivity-based route request or a request to check connectivity in a route from the control unit 22 and sends the connectivity-based route request or the request to check connectivity in a route to the center server 1 through the wireless communication unit 204. A connectivity-based route request is a message to make a request to search for routes having good communication quality. A request to check connectivity in a route is a message to inquire about the communication quality of a designated route. The sending and receiving unit 21 receives route information from the center server 1 through the wireless communication unit 204 and outputs the route information to the control unit 22.

The positional information acquiring unit 23 acquires positional information of the vehicle 20 (in-vehicle apparatus 2), which is acquired by, for example, the GPS receiving unit 205 of the in-vehicle apparatus 2, at predetermined intervals and outputs the positional information to, for example, a predetermined storage area of the memory 202. In the storage area of the memory 202, positional information is, for example, overwritten with an update. The control unit 22 and the navigation unit 24 access the storage area of the memory 202 and acquire the positional information. The positional information of the vehicle 20 contains, for example, a latitude and a longitude. Alternatively, the positional information of the vehicle 20 may be, for example, an address. The interval at which the positional information acquiring unit 23 acquires positional information may be set within, for example, the range of 0.1 seconds to 10 seconds. However, the configuration is not limited thereto.

The navigation unit 24 executes control of route guidance. In the in-vehicle apparatus 2, the navigation unit 24 and the control unit 22 that is, the navigation application and the control program for the in-vehicle apparatus 2 of the route suggestion system 100, cooperate with each other, through, for example, API. The navigation application is running in the foreground of the in-vehicle apparatus 2, while the control program for the in-vehicle apparatus 2 of the route suggestion system 100 is also running in the background. In other words, the navigation application is viewed from a user who operates the in-vehicle apparatus 2, and the user operates the navigation application for input.

For example, an instruction to start a route search is input by a user to the navigation unit 24. The user's operation is, for example, input from the touch panel of the display device connected to the in-vehicle apparatus 2. Together with the instruction to start a route search, at least information about a destination is also input. Other than the destination, for example, information about a departure place, a stopover, and the like, may be input. When no information about the departure place is input, a current position is used as the departure place.

When the instruction to start a route search is input to the navigation unit 24, the navigation unit 24 sends a route request to a server for route search. Together with the route request, information about the destination, and the like, is also sent. Together with this information, the navigation unit 24 outputs a connectivity-based route request to the control unit 22. In response to the route request, for example, information about routes, such as a route of which a required time is short, a route of which a moving distance is short, and a route of which a required fee is low, is received from the server for route search. On the other hand, the connectivity-based route request is sent from the control unit 22 to the center server 1 through the sending and receiving unit 21, and information about routes having good 5G communication quality is received from the center server 1 as a response. The center server 1 may also serve as the server for route search.

When the navigation unit 24 acquires route information from the server for route search and route information from the center server 1, the navigation unit 24 outputs the routes on the display device connected to the in-vehicle apparatus 2 as route search results. Prepared routes to be output are, for example, routes of which a required time is short, routes of which a moving distance is short, routes of which a required fee is low, and routes having good communication quality. When a route for use is selected by a user and an instruction to start guidance is input, the navigation unit 24 starts route guidance. In route guidance, the navigation unit 24 compares the positional information of the in-vehicle apparatus 2 with route information currently in use and provides notification, or the like, in the case of a deviation from an instruction to turn or the route. A process for route guidance may be any known method.

The control unit 22 executes control for acquiring information about routes having good communication quality. When the control unit 22 receives input of a connectivity-based route request from the navigation unit 24, the control unit 22 sends the connectivity-based route request to the center server 1 through the sending and receiving unit 21. Together with the connectivity-based route request, information about the destination, and the like, is also input from the navigation unit 24, and these pieces of information are also sent to the center server 1.

The control unit 22 receives information about routes having good communication quality from the center server 1 through the sending and receiving unit 21 as a response to the connectivity-based route request. The control unit 22 outputs the received information about routes having good communication quality to the navigation unit 24.

The control unit 22 monitors input of a user's operation to the in-vehicle apparatus 2 and processes that are executed by other applications and detects occurrence of a process for which 5G communication is desirably used. Examples of the process for which 5G communication is desirably used include sending or receiving of data larger than or equal to a predetermined size, distribution of streaming and receiving distributed streaming, video call, and sending (IoT communication) of detected data of sensors installed in the vehicle 20.

When the control unit 22 detects occurrence of the process for which 5G communication is desirably used, the control unit 22 sends a connectivity check request on the route currently in use to the center server 1. A connectivity check request is a request to check whether good 5G communication can be performed later in a route currently in use. Together with the connectivity check request, the positional information of the destination and current position, and information about the route currently in use are also sent. These pieces of information are, for example, acquired from the navigation unit 24.

The control unit 22 receives, for example, whether to maintain 5G communication in the route currently in use, information about routes having better communication quality, or the like, from the center server 1 as a response to the connectivity check request on the route currently in use. These pieces of information are received through, for example, push delivery. The control unit 22 outputs whether to maintain 5G communication in the route currently in use, information about routes having better communication quality, or the like, received from the center server 1, to, for example, the display device. After that, for example, when a new route is selected by a user who sees the information displayed on the display device, the control unit 22 provides information about the new route to the navigation unit 24, and the navigation unit 24 starts route guidance for the new route.

The control unit 22 may send the positional information of the vehicle 20 and a measured result of 5G reception field strength to the center server 1 through the sending and receiving unit 21 at predetermined intervals in order for the center server 1 to collect big data.

The center server 1 includes a sending and receiving unit 11, a control unit 12, a field strength map database (DB) 13, and a map information DB 14 as functional components. These functional components are implemented, for example, when the CPU 101 of the center server 1 runs the control program for the center server 1 of the route suggestion system 100, stored in the external storage 103.

The sending and receiving unit 11 controls communication with the in-vehicle apparatus 2 through the communication unit 104. For example, when the sending and receiving unit 11 receives a connectivity-based route request or a connectivity check request on a route from the in-vehicle apparatus 2, the sending and receiving unit 11 outputs the request to the control unit 12. The sending and receiving unit 11 also receives positional information and a measured result of 5G reception field strength from the in-vehicle apparatus 2 and outputs those pieces of information to the control unit 12.

The control unit 12 receives input of the connectivity-based route request or the connectivity check request on a route from the sending and receiving unit 11. Together with the connectivity-based route request, for example, a destination and current position or departure place of the source in-vehicle apparatus 2 is also received. Other than the above, when a stopover, or the like, is designated, information about the stopover, or the like, is also received. When the control unit 12 receives the connectivity-based route request, the control unit 12 executes the following process.

First, the control unit 12 acquires a predetermined number of routes from the current position or departure place of the in-vehicle apparatus 2 to the destination with good communication quality by using the field strength map DB 13 and the map information DB 14.

A method of acquiring routes having good 5G communication quality is, for example, as follows. The control unit 12 initially acquires a predetermined number of routes that run from the current position or departure place of the in-vehicle apparatus 2 to the destination and that satisfy a predetermined condition by using the map information DB 14. The predetermined condition is, for example, any one or combination of a condition that a route is shorter than a distance obtained by adding +α to a distance of the shortest route, a condition that a route requires a time shorter than a time obtained by adding +α to a time of the fastest route, and the like. In other words, first, routes that do not take too much time to reach the destination or do not detour too much are acquired.

Subsequently, the control unit 12 sorts the plurality of acquired routes by consulting the field strength map DB 13 in accordance with the predetermined condition. A sorting condition is, for example, any one or combination of ascending order of the number of sections in which the 5G field strength is lower than a first threshold, ascending order of the total distance of the sections in which the 5G field strength is lower than the first threshold, ascending order of the percentage of the total distance of the sections in which the 5G field strength is lower than the first threshold, descending order of the number of sections in which the 5G field strength is higher than or equal to a second threshold, descending order of the total distance of the sections in which the 5G field strength is higher than or equal to the second threshold, descending order of the percentage of the total distance of the sections in which the 5G field strength is higher than or equal to the second threshold, and the like. The first threshold is a field strength value at which stable 5G communication can be presumably performed. The second threshold is greater than the first threshold. However, the configuration is not limited thereto. The first threshold and the second threshold may be the same value. To sort a plurality of routes in accordance with the condition is, in other words, to sort a plurality of routes in descending order of communication quality.

The control unit 12 sends information about a predetermined number of routes from the top among the routes sorted in descending order of communication quality to the in-vehicle apparatus 2. However, when a route that matches an excluding condition is included in the predetermined number from the top, the route is excluded from the routes to be sent to the in-vehicle apparatus 2. The excluding condition is, for example, any one or combination of a condition that the number of sections in which the 5G field strength is lower than the first threshold is greater than or equal to the predetermined number, a condition that the total distance of the sections in which the 5G field strength is lower than the first threshold is greater than or equal to a threshold, and the like. A method of acquiring routes having good communication quality is not limited to the above-described method and may be any known method.

Subsequently, the control unit 12 receives information about the destination, positional information, and the route currently in use of the source in-vehicle apparatus 2 together with the connectivity check request on the route currently in use. When the control unit 12 receives the connectivity check request, the control unit 12 executes the following process. The control unit 12, for example, determines whether communication quality in a section from the current position to the destination in the route currently in use is good. A determination that communication quality in the section from the current position to the destination in the route that the vehicle 20 equipped with the in-vehicle apparatus 2 is currently using is good depends on, for example, whether a predetermined criterion is satisfied. The predetermined criterion is, for example, any one or combination of a condition that the number of sections in which the 5G field strength is lower than the second threshold is less than a predetermined number, a condition that the total distance of the sections in which the 5G field strength is lower than the second threshold is shorter than a predetermined value, a condition that the percentage of the total distance of the sections in which 5G field strength is lower than the second threshold is less than a predetermined value, and the like. The threshold for the number of sections or the total distance of sections may vary with, for example, the shortest distance from the current position to the destination.

When the control unit 12 determines that the communication quality of the route that the vehicle 20 equipped with the in-vehicle apparatus 2 is currently using is “good”, the control unit 12, for example, does not need to send back any response to the in-vehicle apparatus 2 or may send, to the in-vehicle apparatus 2, a message that 5G communication can be stably continued in the route currently in use.

When the control unit 12 does not determine that the communication quality of the route that the vehicle 20 equipped with the in-vehicle apparatus 2 is currently using is “good”, the control unit 12 acquires a route having better communication quality than the route currently in use. A route having better communication quality than the route currently in use is, for example, any one or combination of a route in which the number of sections in which the 5G field strength is lower than the second threshold is less than that of the route currently in use, a route of which the total distance of the sections in which the 5G field strength is lower than the second threshold is less than that of the route currently in use, a route of which the percentage of the total distance of the sections in which the 5G field strength is lower than the second threshold is less than that of the route currently in use, and the like.

When there is a plurality of routes having better communication quality than the route currently in use, the control unit 12 sorts the routes in descending order of communication quality and sends information about the predetermined number of routes from the top to the in-vehicle apparatus 2. When the control unit 12 does not determine that the communication quality of the route currently in use is “good” and there is no route having better communication quality than the route currently in use, the control unit 12, for example, sends, to the in-vehicle apparatus 2, a message that 5G communication may be unstable later.

The control unit 12 receives positional information and a result of reception field strength from each in-vehicle apparatus 2 at predetermined intervals. When the control unit 12 receives the positional information and measured result of reception field strength of the in-vehicle apparatus 2, the control unit 12 updates the field strength map DB 13 based on the information. The details of the field strength map DB 13 will be described later.

The field strength map DB 13 and the map information DB 14 each are created in the storage area of the external storage 103 of the center server 1. Map information of a region under control of the center server 1 is stored in the map information DB 14.

The functional components of the center server 1 each may be implemented by a process that a different device executes.

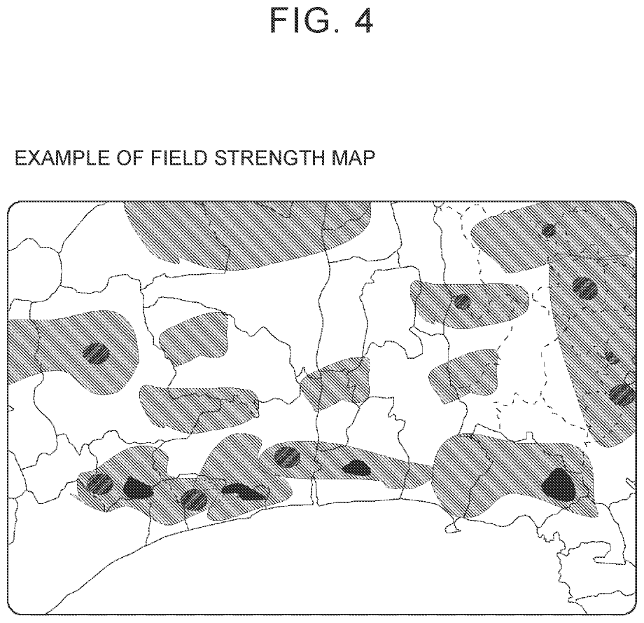

FIG. 4 is a view that shows an example of a field strength map. The field strength map shown in FIG. 4 shows a distribution of 5G field strength in part of the region under control of the center server 1. For example, when the control unit 12 receives positional information and a measured result of reception field strength from the in-vehicle apparatus 2, the control unit 12 draws a plot at a position associated with the positional information of the field strength map. A plot, for example, varies in type, color or the like, in a stepwise manner according to the value of a measured result of reception field strength. In this way, when plots are drawn based on information from the in-vehicle apparatus 2, a distribution of 5G field strength becomes apparent as shown in FIG. 4. In FIG. 4, areas of which the field strength is higher than or equal to the second threshold are the thickest, and areas of which the field strength is higher than or equal to the first threshold and lower than the second threshold are the second thickest.

Identification information of a communication carrier may also be sent from the in-vehicle apparatus 2 together with positional information and a measured result of reception field strength, and a field strength map may be created carrier by carrier. Plots of information after a lapse of a predetermined time from reception may be deleted from the field strength map. With this configuration, the field strength map can be held as the one closer to a present situation. The field strength map shown in FIG. 4 is illustrative. As long as a distribution of field strength is shown, the field strength map may be held in any mode.

Flow of Process

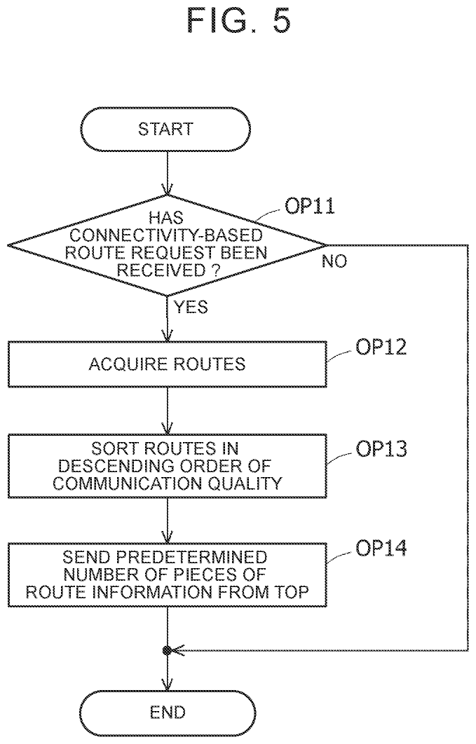

FIG. 5 is an example of a flowchart of a process that the center server 1 executes upon receiving a connectivity-based route request from the in-vehicle apparatus 2. A connectivity-based route request is received from the in-vehicle apparatus 2 when a request for a route to a destination is input to the in-vehicle apparatus 2 by a user in the vehicle 20. The process shown in FIG. 5 is repeatedly executed at predetermined intervals while the center server 1 is in operation. A subject that executes the process shown in FIG. 5 is the CPU 101; however, description will be made on the assumption that the functional components are subjects for the sake of convenience in FIG. 5. This also applies to the flowchart of the center server 1 (described later).

In OP11, the control unit 12 determines whether a connectivity-based route request has been received from the in-vehicle apparatus 2 through the sending and receiving unit 11. When a connectivity-based route request has been received from the in-vehicle apparatus 2 (YES in OP11), the process proceeds to OP12. When no connectivity-based route request has been received from the in-vehicle apparatus 2 (NO in OP11), the process shown in FIG. 5 ends.

In OP12, the control unit 12 calculates routes to a destination by using the map information DB 14. Together with the connectivity-based route request, positional information about the destination and a departure place or current position are also received from the in-vehicle apparatus 2. In OP12, the control unit 12 acquires a predetermined number of routes that run from the current position or departure place of the in-vehicle apparatus 2 to the destination and that satisfy a predetermined condition by using the map information DB 14. The predetermined condition is, for example, any one or combination of a condition that a route is shorter than a distance obtained by adding +α to a distance of the shortest route, a condition that a route requires a time shorter than a time obtained by adding +α to a time of the fastest route, and the like.

In OP13, the control unit 12 sorts the predetermined number of routes acquired in OP12 in descending order of communication quality by consulting the field strength map DB 13. A sorting condition is, for example, any one or combination of ascending order of the number of sections in which the 5G field strength is lower than a first threshold, ascending order of the total distance of the sections in which the 5G field strength is lower than the first threshold, ascending order of the percentage of the total distance of the sections in which the 5G field strength is lower than the first threshold, descending order of the number of sections in which the 5G field strength is higher than or equal to a second threshold, descending order of the total distance of the sections in which the 5G field strength is higher than or equal to the second threshold, descending order of the percentage of the total distance of the sections in which the 5G field strength is higher than or equal to the second threshold, and the like.

In OP14, the control unit 12 sends information about a predetermined number of routes from the top among the routes sorted in descending order of communication quality to the in-vehicle apparatus 2. However, when a route that matches an excluding condition is included in the predetermined number from the top, the route is excluded from the routes to be sent to the in-vehicle apparatus 2. After that, the process shown in FIG. 5 ends. The routes sent to the in-vehicle apparatus 2 are, for example, displayed on the route selection screen of the in-vehicle apparatus 2 as routes having good 5G communication quality. The process in the case where a connectivity-based route request has been received from the in-vehicle apparatus 2, shown in FIG. 5, is illustrative, and the process is not limited to the process shown in FIG. 5.

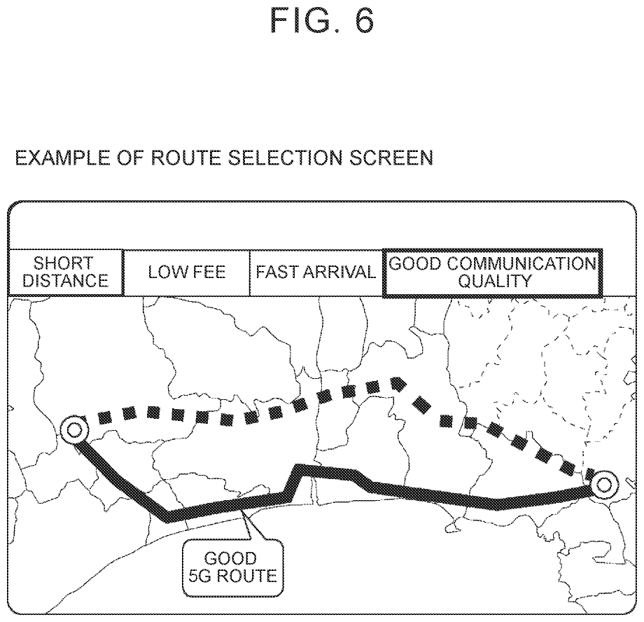

FIG. 6 is a view that shows an example of the route selection screen of the in-vehicle apparatus 2. The route selection screen shows routes received as a response to a route request sent from the in-vehicle apparatus 2 to the server for route search and the center server 1 in accordance with an instruction to start a route search, input to the in-vehicle apparatus 2 by a user. In FIG. 6, four tabs, that is, “SHORT DISTANCE”, “LOW FEE”, “FAST ARRIVAL”, AND “GOOD COMMUNICATION QUALITY”, are contained. When any one of the tabs is selected, a plurality of routes compliant with a criterion indicated by the selected tab is shown. In FIG. 6, the tab “GOOD COMMUNICATION QUALITY” is selected, and top two routes in descending order of communication quality are shown.

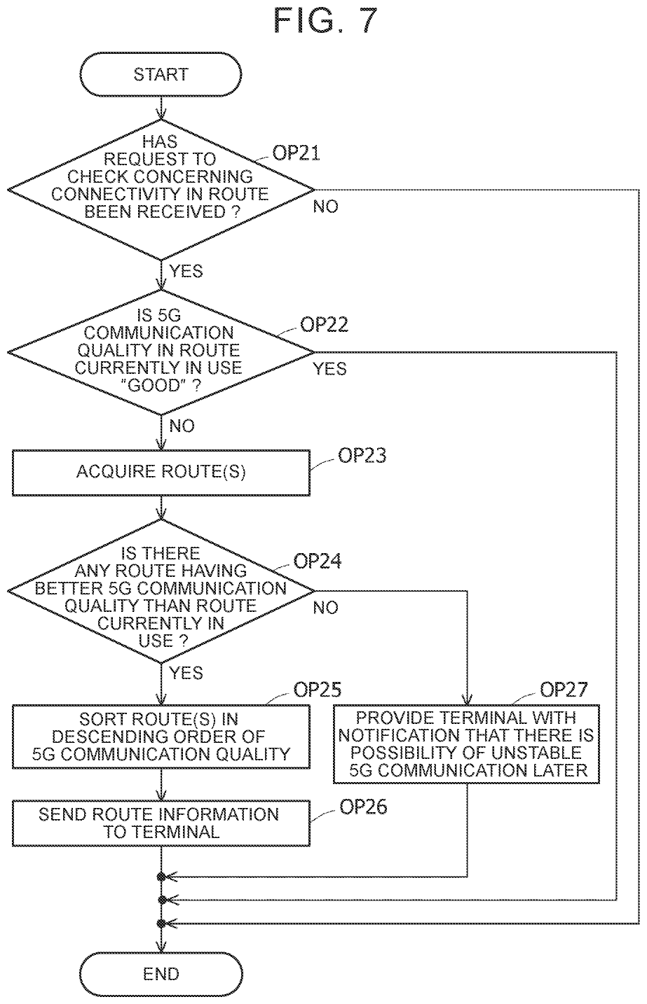

FIG. 7 is an example of a flowchart of a process that the center server 1 executes upon receiving a request to check connectivity in a route from the in-vehicle apparatus 2. A request to check connectivity in a route is sent from the in-vehicle apparatus 2 to the center server 1, for example, when a process for which 5G communication is desirably used occurs in the in-vehicle apparatus 2. The process shown in FIG. 7 is, for example, repeatedly executed at predetermined intervals while the center server 1 is in operation.

In OP21, the control unit 12 determines whether a request to check connectivity in a route has been received from the in-vehicle apparatus 2. When a request to check connectivity in a route has been received from the in-vehicle apparatus 2 (YES in OP21), the process proceeds to OP22. When no request to check connectivity in a route has been received from the in-vehicle apparatus 2 (NO in OP21), the process shown in FIG. 7 ends.

In OP22, the control unit 12 determines whether the communication quality of a section from a current position to a destination in a route that the vehicle 20 equipped with the in-vehicle apparatus 2 is currently using is good. Together with the request to check connectivity in a route, for example, the positional information of the in-vehicle apparatus 2, the destination, and information about the route currently in use are also received from the in-vehicle apparatus 2. The communication quality of the section from the current position to the destination in the route that the vehicle 20 equipped with the in-vehicle apparatus 2 is currently using is determined to be good, for example, when 5G communication quality in the section satisfies a predetermined criterion. The predetermined criterion is, for example, any one or combination of a condition that the number of sections in which the 5G field strength is lower than the second threshold is less than the predetermined number, a condition that the total distance of the sections in which the 5G field strength is lower than the second threshold is shorter than the predetermined value, a condition that the percentage of the total distance of the sections in which 5G field strength is lower than the second threshold is less than the predetermined value, and the like. When the control unit 12 determines that the communication quality of the section from the current position to the destination in the route that the vehicle 20 equipped with the in-vehicle apparatus 2 is currently using is “good” (YES in OP22), the process shown in FIG. 7 ends. When the control unit 12 does not determine that the communication quality of the section from the current position to the destination in the route that the vehicle 20 equipped with the in-vehicle apparatus 2 is currently using is “good” (NO in OP22), the process proceeds to OP23.

In OP23, the control unit 12, for example, acquires a route from the current position to the destination by using the map information DB 14. In OP24, the control unit 12 determines whether there is a route having better communication quality than the route that the vehicle 20 equipped with the in-vehicle apparatus 2 is currently using among the routes acquired in OP23. A route having better communication quality than the route currently in use is, for example, any one or combination of a route in which the number of sections in which the 5G field strength is lower than the second threshold is less than that of the route currently in use, a route of which the total distance of the sections in which the 5G field strength is lower than the second threshold is less than that of the route currently in use, a route of which the percentage of the total distance of the sections in which the 5G field strength is lower than the second threshold is less than that of the route currently in use, and the like.

When there is/are a route(s) having better communication quality than the route that the vehicle 20 equipped with the in-vehicle apparatus 2 is currently using among the routes acquired in OP23 (YES in OP24), the process proceeds to OP25. When there is no route having better communication quality than the route that the vehicle 20 equipped with the in-vehicle apparatus 2 is currently using among the routes acquired in OP23 (NO in OP24), the process proceeds to OP27.

In OP25, the control unit 12 sorts the route(s) having better communication quality than the route that the vehicle 20 equipped with the in-vehicle apparatus 2 is currently using in descending order of communication quality. In OP26, the control unit 12 sends information about the predetermined number of routes from the top to the in-vehicle apparatus 2. At this time, for example, information about the routes is sent to the in-vehicle apparatus 2 through push delivery. After that, the process shown in FIG. 7 ends. In the in-vehicle apparatus 2, the information about the route(s) having better communication quality than the route currently in use, sent from the center server 1, is displayed on the display device.

In OP27, the control unit 12 does not determine that the communication quality of the route currently in use is good and determines that there is no route having better communication quality than the route currently in use, so the control unit 12 sends, to the in-vehicle apparatus 2, a message that 5G communication may be unstable later. After that, the process shown in FIG. 7 ends. The process that the center server 1 executes upon receiving a request to check connectivity in a route from the in-vehicle apparatus 2 is not limited to the process shown in FIG. 7 and may be modified as needed according to embodiments. For example, the process of determination as to the communication quality of the route that the vehicle 20 equipped with the in-vehicle apparatus 2 is currently using in OP22 may be omitted.

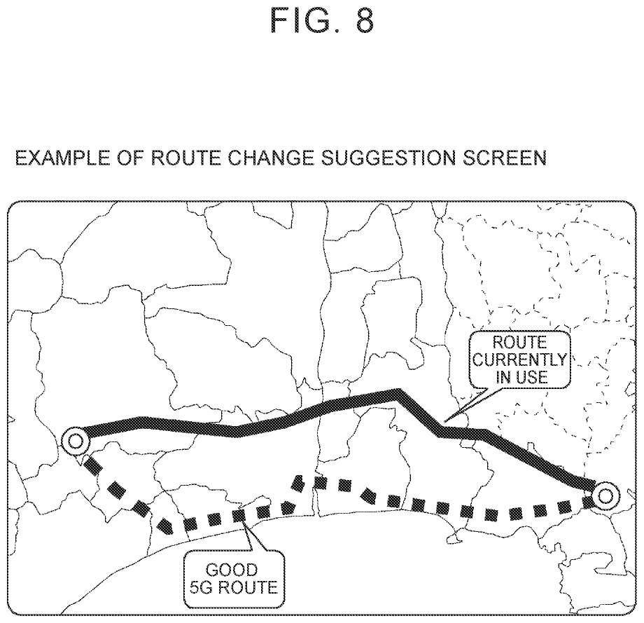

FIG. 8 is a view that shows an example of a route change suggestion screen of the in-vehicle apparatus 2. The route change suggestion screen is a screen that is displayed on the display device of the in-vehicle apparatus 2 when information about a route having better communication quality than the route currently in use has been received from the center server 1. In FIG. 8, the route currently in use is indicated by the continuous line, and a route having better communication quality and suggested from the center server 1 is indicated by the dotted line.

A route having better communication quality than the current route is suggested by the route change suggestion screen. When the route is newly adopted, the in-vehicle apparatus 2 is able to stably continue 5G communication.

### Operation and Advantageous Effects of First Embodiment

In the first embodiment, a route that takes 5G communication quality into consideration is provided to the in-vehicle apparatus 2. Thus, for example, a route having good 5G communication quality can be selected, and, when the vehicle 20 travels along the route, the in-vehicle apparatus 2 installed in the vehicle 20 is able to receive services through 5G communication having large-capacity, low-delay characteristics.

In the first embodiment, when a process for which 5G communication is desirable occurs in the in-vehicle apparatus 2, a route having better communication quality than a route that the vehicle 20 is currently using is suggested. Thus, the route can be changed to a route having good communication quality even while the vehicle 20 is traveling, so the in-vehicle apparatus 2 is able to perform stable 5G communication. On the other hand, when there is no route having better communication quality than a route that the vehicle 20 is currently using and it is not determined that the communication quality currently in use is good, the possibility that communication may be unstable is informed. Thus, for example, a user of the in-vehicle apparatus 2 is able to prepare for unstable 5G communication by interrupting a download of a massive amount of data, changing data to smaller one, or the like.

### OTHER EMBODIMENTS

The above-described embodiment is only illustrative, and the disclosure can be implemented with modifications as needed without departing from the purport of the disclosure.

In the first embodiment, the center server 1 has the field strength map and acquires a route(s) having better communication quality; however, the disclosure is not limited thereto. For example, the in-vehicle apparatus 2 may have a field strength map and map information and may acquire a route(s) having better communication quality without intervening the server 1.

In the first embodiment, the description is made by way of the in-vehicle apparatus 2 as an example. Alternatively, the process of the in-vehicle apparatus 2 in the first embodiment is also applicable to, for example, walking with a smartphone, a tablet terminal, a wearable terminal, or the like.

In the first embodiment, a route having good 5G communication quality is sought; however, not limited to 5G, for example, 4G, a communication system after 5G, or the like, may be applied.

The processes and devices described in this disclosure may be freely implemented in combination without any technical contradiction.

A process described as the one that a single apparatus executes may be executed by a share of a plurality of apparatuses. Alternatively, processes described as the ones that different apparatuses execute may be executed by a single apparatus. In a computer system, what hardware configuration (server configuration) implements functions may be flexibly changed.

The disclosure may also be implemented as follows. A computer is supplied with a computer program having the functions described in the above-described embodiment, and one or more processors of the computer read out and run the program. Such a computer program may be provided to a computer with a non-transitory computer-readable storage medium connectable to a system bus of the computer or may be provided to a computer via a network. Examples of the non-transitory computer-readable storage medium include a disk or disc of any type, such as a magnetic disk (floppy (registered trademark) disk, a hard disk drive (HDD), or the like), an optical disc (CD-ROM, DVD disc, a Blue-ray disc, or the like), a read only memory (ROM), a random access memory (RAM), an EPROM, an EEPROM, a magnetic card, a flash memory, an optical card, and a medium of any type suitable for storing electronic instructions.

What is claimed is:

1. An information processing apparatus comprising a processor configured to:
receive, from a terminal, information about a departure place or a current position and information about a destination;
based on field strength map information indicating a distribution of field strength in a first communication system, acquire a route from the departure place or the current position to the destination, of which communication quality in the first communication system satisfies a predetermined criterion; and
send information about the acquired route to the terminal.

2. The information processing apparatus according to claim 1, wherein the processor is configured to:
receive, from the terminal, information about a route currently in use;
determine whether communication quality in the first communication system in at least a section from the current position of the terminal to the destination in the route currently in use satisfies the predetermined criterion;
when the communication quality in the first communication system in the section does not satisfy the predetermined criterion, acquire a first route from the current position of the terminal to the destination, of which communication quality in the first communication system satisfies the predetermined criterion; and
send information about the first route to the terminal.

3. The information processing apparatus according to claim 2, wherein the processor is configured to, when the communication quality in the first communication system in the section does not satisfy the predetermined criterion and the first route is not acquired, provide the terminal with notification that there is a possibility of unstable communication in the first communication system.

4. The information processing apparatus according to claim 1, wherein the field strength map information is created based on information about positions of one or more terminals and information about a reception field strength in the first communication system at each of the positions, sent from the one or more terminals.

5. An information processing method comprising:
receiving, from a terminal, information about a departure place or a current position and information about a destination;
based on field strength map information indicating a distribution of field strength in a first communication system, acquiring a route from the departure place or the current position to the destination, of which communication quality in the first communication system satisfies a predetermined criterion; and
sending information about the acquired route to the terminal.
